(19) United States
(12) Patent Application Publication
(10) Pub. No.: US 2018/0321092 A1
(43) Pub. Date: Nov. 8, 2018

(54) DIGITAL SENSOR

(71) Applicant: PST SENSORS (PROPRIETARY) LIMITED, Cape Town (ZA)

(72) Inventors: Stephen David JONES, Claremont (ZA); Emmanuel Ohieku JONAH, Pinelands (ZA); Margit HARTING, Mowbray (ZA); David Thomas BRITTON, Cape Town (ZA)

(73) Assignee: PST SENSORS (PROPRIETARY) LIMITED, Cape Town (ZA)

(21) Appl. No.: 15/776,898

(22) PCT Filed: Nov. 16, 2016
(86) PCT No.: PCT/IB2016/056894

§ 371 Date: May 17, 2018

(30) Foreign Application Priority Data
Nov. 18, 2015 (ZA) 2015/08532

(51) Int. Cl. G01K 7/24

(52) U.S. Cl. CPC G01K 7/24

(57) ABSTRACT

A hybrid electronic sensing component comprises an integrated circuit attached to an analogue circuit into which at least one sensing element has been integrated. The hybrid sensing component provides an output in digital form in response to a quantifiable change in its environmental conditions. The sensing functionality is separated from the data processing, which reduces the effect of self-heating due to the power consumption in the processor.

### BACKGROUND OF THE INVENTION

THIS invention relates to an environmental sensing device and a method of fabricating such a device.

In particular the invention relates to a compound electronic component which monitors the change in an environmental condition by a change in electrical resistance of one of its sub-components and communicates the value of the environmental condition in digital form to an external electronic circuit. Of particular interest is the monitoring and communication of temperature, which has a huge demand in all aspects of life across all market sectors, from the transport and storage of perishable goods to industrial process monitoring and healthcare.

A temperature sensor with digital output, often referred to as a “sensor on chip”, is well known in the art, and is available as a single integrated circuit or integrated into a larger integrated circuit such as a microprocessor. Often the primary function of such a sensor is to monitor the internal temperature of the microprocessor. Generally, such internal sensors of this type comprise small semiconductor junctions with a high conductance, which depends on the temperature at the junction. When used for determining the temperature of an external body or the external environment, the digital sensors known in the art are undesirable.

One problem with a sensor on chip is that the high current density through the junction results in a strong local self-heating, which is exacerbated by the poor thermal conduction away from the junction. This leads to an erroneous determination of the temperature as being significantly higher than the actual temperature of the object being monitored.

Other factors, which affect the response of the digital temperature sensor, are its high thermal mass relative to its physical size, particularly its contact area, and the thermal coupling to the object being monitored.

A preferred method of determining temperature via an electrical measurement is to use a component whose electrical resistance varies with temperature, for example a thermistor. Printed thermistors can be manufactured with high electrical resistances, often in excess of 1 MΩ, or even up to several hundreds of MΩ, which results in very low current through the device and hence very low power consumption, and effectively no self-heating. A further advantage of using a printed thermistor is that, when printed on a thin substrate, its thermal mass is low in relation to its area and with a large area good thermal coupling can be achieved. Hence faster response times and more precise measurement are possible.

Nevertheless, for many applications, digital temperature sensors are preferred because of their ease and convenience of use compared to traditional analogue components such as thermistors, for example. A particular advantage is the direct output of a calibrated digital value for the temperature in units, such as Celcius or Fahrenheit, which make sense to the user.

It is therefore an object of this invention to produce an electronic component for monitoring an environmental condition, such as temperature, and reporting the result, which has all the advantages of providing a calibrated digital value for the monitored condition and the technical advantages of a printed thermistor. The same construction is applicable to any other environmental monitoring, for example humidity or pressure, in which a resistive sensor may be applied.

### SUMMARY OF THE INVENTION

According to one aspect of the invention, an electronic sensing component, which provides an output in digital form in response to a quantifiable change in an environmental condition, comprises an analogue circuit into which at least one sensing element, the resistance of which varies in relation to the change in the environmental condition, is integrated, at least one other resistor whose resistance remains constant with the change in the environmental condition, and at least one integrated circuit, which are connected such that when a potential difference is applied across the analogue circuit, two potentials, one of which corresponds to the environmental condition to be measured and the other corresponds to a reference value, are applied to the input terminals of the integrated circuit, thereby generating a unique digital signal at one or more of its output terminals, where the unique digital signal corresponds to the change in the environmental condition being measured.

In some embodiments of the invention, the sensing element is a negative temperature coefficient thermistor, the resistance of which decreases as its temperature increases.

Preferably, at least the thermistor and the interconnections in the analog circuit are manufactured by printing.

In some embodiments of the invention two resistors of constant value are connected in series with the sensing element such that the two potentials applied to the inputs of the integrated circuits are the potential difference across one of the resistors of constant value, and the potential difference across the said resistor of constant value and the sensing element, respectively.

In some embodiments of the invention, the potential(s) is/are applied to independent analog to digital converters or to a single analog to digital converter through a multiplexer.

In some embodiments of the invention, the integrated circuit comprises a microcontroller or microprocessor, which performs additional calculation on the data before providing the digital value at one or more of its output terminals.

In some embodiments of the invention, the digital output is provided through a serial interface.

In some embodiments of the invention, the digital output is provided through a parallel interface using a multiplicity of output terminals simultaneously.

The output of one integrated circuit in some embodiments is connected to a second integrated circuit comprising non-volatile memory.

In some embodiments of the invention the microcontroller is connected to or integrated with a wireless transceiver integrated circuit and an antenna is integrated into or connected to the analog circuit.

### BRIEF DESCRIPTION OF THE DRAWINGS

The invention will now be described in more detail, by way of example only, with reference to the accompanying drawings in which:

FIG. 1 is a schematic diagram of a first embodiment of a hybrid electronic digital sensor of the invention comprising an analogue electronic circuit with an integrated resistive sensor, fabricated on a substrate to which a digital electronic integrated circuit is attached;

FIG. 2 is a schematic diagram of a second embodiment of a hybrid electronic sensor of the invention, which can function autonomously of the external electronics circuit by the addition of a digital non-volatile memory and a rechargeable battery;

FIG. 3 is a schematic diagram of a wireless sensing system comprising the hybrid electronic sensor, of which the analogue part has been integrated with an antenna on the same substrate and to which a wireless transceiver has been attached for external communication; and

FIG. 4 is a photograph of a hybrid digital electronic temperature sensor fabricated according to an embodiment of the present invention.

### DESCRIPTION OF PREFERRED EMBODIMENTS

In simple terms, the present invention is an inversion of the “concept of a sensor” on chip, to produce a “chip on sensor” with the same functionality, but better performance than the prior art. Such a device is necessarily a hybrid electronic sensing component in which an integrated circuit is attached to an analogue circuit into which at least one sensing element has been integrated. The hybrid sensing component provides an output in digital form in response to a quantifiable change in its environmental conditions.

Functionally, however, the sensing is separated from the data processing, which reduces the effect of self-heating due to the power consumption in the processor. This separation of the two functions inside the compound component further enables the sensor to be designed to have a form and performance that is appropriate to a specific application. The resistance of the sensing element varies in relation to an environmental change, for example the temperature. Resistance cannot be measured directly, so the sensing element is integrated in the analogue part of the component with at least one other resistor whose resistance remains constant with the environmental change. These are connected such that when a potential difference is applied across the analogue circuit, two potentials, one of which corresponds to the condition to be measured and the other corresponds to a reference value, are applied to the input of an integrated circuit.

The integrated circuit generates a unique digital signal corresponding to the combination of the two potentials, and hence to the environmental condition being monitored. This unique digital signal may be as simple as the numerical value of the ratio of the two potentials, or may be the result of the application of a complex calibration function to yield a meaningful quantity in the correct units, for example the temperature in Celcius, a force in Newtons, or relative humidity in %.

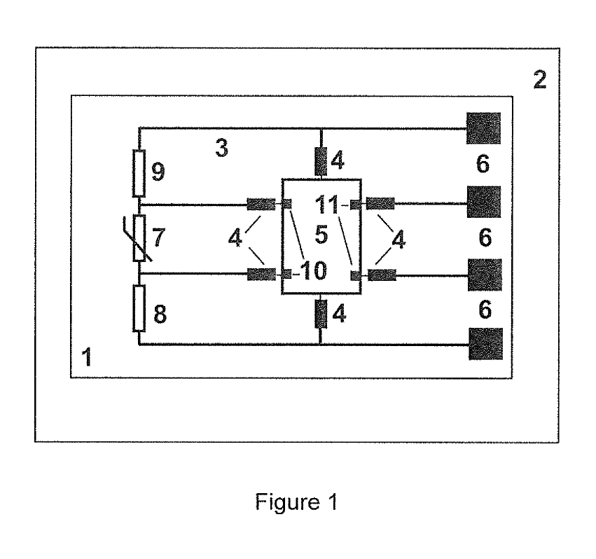

Turning to the illustrated embodiments of the invention, in a first embodiment, shown in accompanying FIG. 1, an analogue sensing circuit 1 is fabricated on a substrate 2. The substrate may be a sheet material or it may form part of the body of the object, the environment of which is to be sensed.

In the case of a substrate formed from a sheet material, the sheet may be rigid or flexible, and may be a solid film, a fibrous material which may be woven or non-woven, or a composite of a combination of such materials. Suitable solid films include: polymers, such as but not limited to polyethylene terephthalate (commonly known as PET or polyester), polyethelene napthalate (PEN), polyimide (PI, Kapton, Vespel); metal foil, including but not limited to aluminium, iron, copper and their alloys; amorphous oxides and silicates, generally referred to as glasses; single and polycrystalline semiconductor materials such as silicon; and sintered ceramic materials. Fibrous materials are generally those referred to as: papers, including but not limited to cellulose fibres of vegetable origin, synthetic polymer fibres, for example polyester, polyamide, polyimide, as well as glass and ceramic fibres; and woven or non-woven fabrics comprising natural fibres of animal or vegetable origin, synthetic polymer fibres, and glass or ceramic fibres, including but not limited to cellulose, keratin, polyester, polyimide, polyamide, and aramid.

Composite materials may include fibre composites comprising, for example, a woven or non-woven fabric reinforced with a solidified polymer resin, or a polymer filled with a fibrous or particulate filler material. Alternatively, a composite material may be formed from layers of different sheet materials as described above, the orientation of which may be parallel to the surface of the substrate, perpendicular to it, or inclined at any other angle to the surface. Generally, as is well known in the art, the latter construction is employed to alter the mechanical properties of the sheet material, for example to increase stiffness or strength, whereas aligning the layers parallel to the surface is most often used to present a surface of a different material. Examples of such include, but are not limited to: an insulating layer applied to the conducting surface of a metal sheet, or a surface coating applied to a polymer film to improve the adhesion of materials deposited, for example inks and adhesives, during the fabrication of the invention.

An example of an instance in which the substrate forms part of the body of the object would be that of a sensor system integrated into the housing or case of an instrument. Alternatively such a system could be integrated as part of a larger electronic circuit, in which case the substrate would be the circuit board of the device.

The analogue circuit 1 is preferably fabricated by one of the methods generally described as printing by practitioners in the electronics manufacturing, graphics, and media and communications industries, including but not limited to screen printing, gravure printing, pad printing, flexography, letterpress, offset lithography, inkjet printing, and aerosol jet printing. Alternatively, some or all parts of the circuit may be fabricated by other coating and deposition techniques known in the above named industries, including but not limited to using photolithography, imprint lithography or similar to produce a mask in combination with deposition techniques such as chemical vapour deposition, physical vapour deposition, spin coating, blade coating or slot-die coating.

The analogue circuit comprises a pattern of conductors 3 forming the internal circuit connections, which are often referred to as interconnects or wiring. The pattern of conductors includes connecting pads 4 which are used for mounting and connecting individual components, including in an integrated circuit 5 any additional electronic components, such as resistors, capacitors, diodes and the like, which form parts of the whole component. The pattern of conductors further includes additional connecting pads 6, which serve as external connections or terminals to the component, for example for the supply of electrical power and the transfer of data.

An important aspect of the invention is that a resistive sensor element 7 is integrated into the analogue circuit 1. In the sense of this invention, the term integrated means that the sensor 7 is fabricated on the same substrate 2 as the pattern of conductors 3 using the same fabrication processes with at least one fabrication step common to the fabrication of both the conducting pattern 3 and the sensor element 7. The description of the sensor element 7 as resistive means that its electrical resistance varies in relation to a change in its immediate environment. In a preferred embodiment, the sensor element 7 functions as a negative temperature coefficient (NTC) thermistor, the electrical resistance of which decreases as the temperature increases. Preferably this sensor 7 is produced by the printing of a silicon ink onto a conducting pattern as described in U.S. Pat. No. 9,029,180, incorporated herein by reference. Without restriction, the integrated negative temperature coefficient thermistor may be replaced by a positive temperature coefficient thermistor, the resistance of which increases with increasing temperature, or a metal film resistor, for example platinum, which functions as an RTD (resistive temperature device) with its resistance increasing linearly with increasing temperature. Other sensor elements which may be incorporated in the same manner include, but are not limited to: humidity or chemical sensors fabricated from materials whose conductivity changes in the presence of moisture or a specific target chemical, respectively, and pressure or strain sensors fabricated from piezoresistive materials.

Additionally the analogue circuit 1 contains at least a second resistor 8, and preferably a third resistor 9. The resistors 8 and 9 are fixed or constant in the sense that their electrical resistance does not vary strongly with the environmental change being sensed. For example, if the sensor element 7 is an NTC thermistor, the resistors 8 and 9 should be substantially temperature independent. If the electrical resistance of the resistors 8 or 9 has a weak dependence on the change in environmental conditions, it is preferred that this change is in the opposite sense to the change in the resistance of the sensor element 7. For example, if the sensor element 7 is an NTC thermistor, the substantially temperature independent resistors 8 and 9 may have a weak positive temperature coefficient of resistance, i.e. their resistance may increase slightly with increasing temperature, but this change should be significantly smaller, preferably by at least an order of magnitude, than that of the sensor element 7.

Preferably the resistor 8 and the resistor 9 are also integrated into the analogue circuit 1 in the same manner as the sensor element 7. For example if the sensor element 7 is printed, as described in U.S. Pat. No. 9,029,180, then the resistors 8 and 9 may be printed in a similar manner using a suitable resistor ink composition. Alternatively, one or more of the resistors 8 and 9 may be supplied as an additional component which is attached to and connected via contact pads in the analogue circuit 1.

When a potential difference or voltage is applied across the analogue circuit 1, or a current is passed through it, via the external connections 6, two or more potentials are applied via the conducting pattern 3 and the connecting pads 4 to the input terminals 10 of the integrated circuit 5. One of these potentials corresponds to the measurement condition to be determined, for example the temperature, and the second to an internal reference value, for example the total potential difference applied across the sensor and one or more resistors. The integrated circuit may perform various actions internally before supplying to one or more of its output terminals 11 a unique digital signal, which corresponds unambiguously to the combination of the two or more potentials applied to its input terminals.

In a preferred embodiment the integrated circuit 5 is a microcontroller or microprocessor, which has at least two analogue inputs. These inputs may be either connected internally to independent analogue to digital converter (ADC) channels, or be multiplexed to a single ADC. Alternatively, additional integrated circuits may be attached to the analogue circuit as an input stage to the microprocessor or microcontroller. As an example, one or more independent ADCs may be connected to digital inputs, or a multiplexer may be used as an input stage to a single analogue input. It may be further desirable to combine an independent multiplexer and a single ADC together as an input stage to a digital input of the microcontroller or microprocessor.

It is also possible, but undesirable to only use a multiplexer and an ADC, so that digital outputs of the ADC are connected to the output terminals. However, this embodiment is not preferred as the use of a microcontroller provides additional functionality to the whole component. This functionality is provided by the capability of performing additional calculations on the sensor data to provide a calibrated numerical value. This may be as simple as calculating the ratio of the potentials applied to the analogue input terminals, or a calibration function may be applied to estimate either the actual value or the change in the environmental condition being monitored. For example, in the case of a temperature sensor, actual temperature may be output in a chosen temperature scale, such as Celcius or Fahrenheit.

In a preferred embodiment, the value calculated and output by the integrated circuit is transmitted through one or more output terminals in a serial format. Any industry standard protocol, including but not limited to SRI, I²C, UART, one-wire, two-wire, or three-wire, may be used. In another preferred embodiment, multiple output terminals may be used simultaneously to transmit the numerical value in parallel format, with one terminal corresponding to one bit of information, where the information may include control characters and text labels as well as the numerical value.

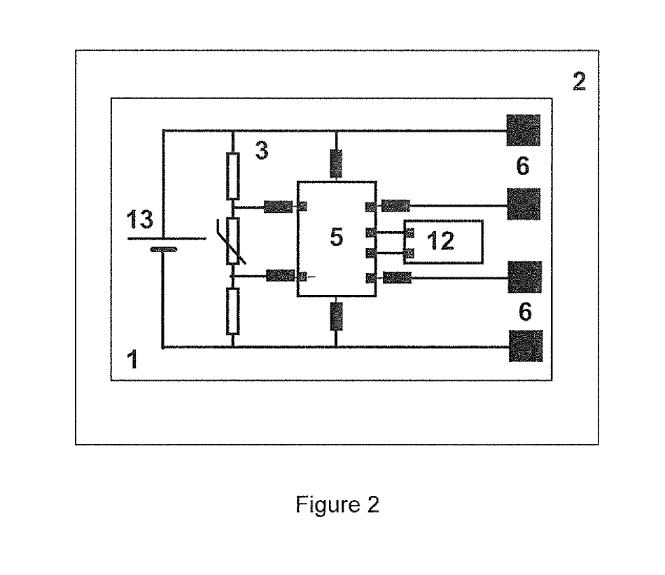

In a further preferred embodiment, shown in accompanying FIG. 2, an additional integrated circuit 12, comprising a non-volatile memory is attached to the substrate 2. The integrated circuit 12 is connected to the one or more digital input/output terminals of the integrated circuit 5, which is preferably a microcontroller or microprocessor, to form a digital portion of the whole circuit. Preferably, the connection between the two integrated circuits is integrated into the conducting pattern 3 used for the analogue portion of the circuit. The connection between the digital input/output terminals of the two integrated circuits may be facilitated using either a serial or parallel data format, in a similar manner to the data transfer to the external connections.

An internal battery (or cell) 13 may also be attached across the external connections used to supply power from an external source, to allow the sensor and microcontroller to function autonomously of any external connections. In this manner, the component may function as a data logger as well as a sensor. Ideally the battery 13 is a rechargeable battery, but equally an electrolytic capacitor, a supercapacitor, a primary cell, a photovoltaic cell or any other source of potential may be applied.

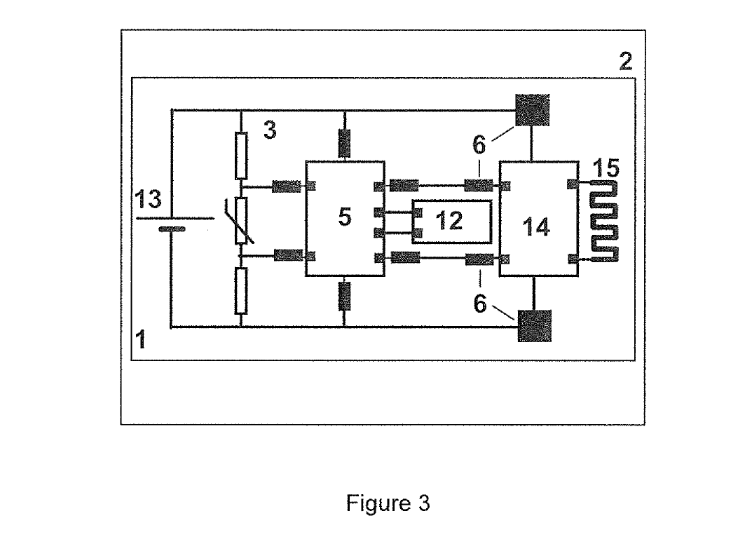

The hybrid electronic sensor of any of the above embodiments can be connected through the external data and power connections 6 to further electronic circuits to form a complete sensing system. For example, as shown in accompanying FIG. 3 the integrated circuit 5 can communicate its data to a wireless transceiver 14 using a serial or parallel data protocol. The antenna 15 and power connections to the transceiver may further be integrated into the analogue sensor circuit 1 formed by the conducting pattern 3 on the same substrate 2. If the rechargeable battery 13 is also included, energy can be harvested from the radiation field to provide power for the sensor and the integrated circuit.

The invention is further illustrated with reference to the following non-limiting example.

### EXAMPLE 1

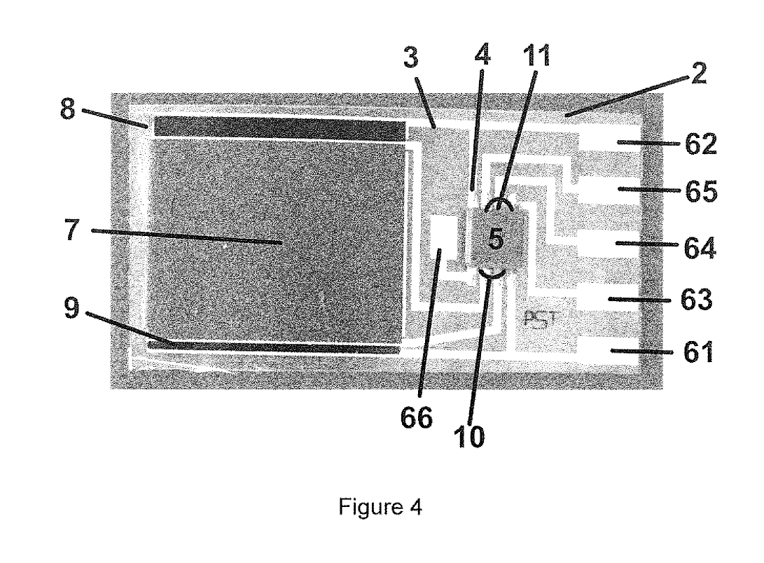

FIG. 4 shows a photograph of a hybrid electronic digital temperature sensor constructed according to the first embodiment shown in FIG. 1. The complete component is assembled onto a laminated PET sheet, of total thickness approximately 0.25 mm, which serves as the substrate 2. A conducting pattern 3, comprising the interconnects, connecting pads 4 and external terminals 61-66, as well as the internal electrode structures of the NTC thermistor 7 and the substantially temperature independent resistors 8 and 9, is deposited by screen printing using a silver based ink. Many suitable compositions are readily available, for example DuPont 5000 silver conductor which has been used in the examples presented here.

The integrated circuit 5 used in this example is an 8-bit microcontroller in an SOP-8 package, which has the same footprint as the SOIC-8 package. In this example, the microcontroller is an ATTiny85 from Atmel Corporation. The integrated circuit is attached to the connecting pads 4 using a conducting adhesive. The external connections are effected through six terminals 61-66 as follows: V_{CC} a negative supply voltage or common zero 61; V_{SS} a positive supply voltage 62 which may not exceed the specifications of the microcontroller; serial digital transmit T_{X} 63; serial digital receive Rx 64; and a chip select 65. An additional terminal 66 was provided for on-board programming during development, and provides a chip reset function. An alternative configuration for terminals 63-65 as Master Out/Slave In (MOSI), Master In/Slave Out (MISO), and an external clock may also be applied.

Both the NTC thermistor 7 and the substantially temperature independent resistors 8 and 9 are fabricated by screen printing directly onto the printed silver pattern, as described U.S. Pat. No. 9,029,180 and PCT publication WO2013114289, also incorporated herein by reference. As shown in Figure 1, these three resistors are connected in series with each other and have the same power supply as the microcontroller. The intersections between the thermistor and each resistor are connected by the conducting pattern 3 through the connecting pads 4 to two inputs of the microcontroller 10 which are configured as 10 bit ADCs. Hence the input to the microcontroller comprises independent measurements of the potential difference across the resistor 9 and the combined potential difference across the resistor 9 and thermistor 7 together. The ratio of these two potentials provides a unique measure of the temperature experienced by the sensor. Using a calibration function stored in the microcontroller, this ratio is converted into the numerical value of the temperature on an appropriate scale.

1. An electronic sensing component, which provides an output in digital form in response to a quantifiable change in an environmental condition, comprising an analogue circuit into which at least one sensing element, the resistance of which varies in relation to the change in the environmental condition, is integrated, at least one other resistor whose resistance remains constant with the change in the environmental condition, and at least one integrated circuit, which are connected such that when a potential difference is applied across the analogue circuit, two potentials, one of which corresponds to the environmental condition to be measured and the other corresponds to a reference value, are applied to the input terminals of the integrated circuit, thereby generating a unique digital signal at one or more of its output terminals, where the unique digital signal corresponds to the change in the environmental condition being measured.

2. An electronic sensing component according to claim 1, wherein the sensing element is a negative temperature coefficient thermistor, the resistance of which decreases as its temperature increases.

3. An electronic sensing component according to claim 2, wherein at least the thermistor and the interconnections in the analog circuit are manufactured by printing.

4. An electronic sensing component according to claim 1, wherein two resistors of constant value are connected in series with the sensing element such that the two potentials applied to the inputs of the integrated circuits are the potential difference across one of the resistors of constant value, and the potential difference across the said resistor of constant value and the sensing element, respectively.

5. An electronic component according to claim 1, wherein the potential(s) is/are applied to independent analog to digital converters or to a single analog to digital converter through a multiplexer.

6. An electronic component according to claim 1, wherein the integrated circuit comprises a microcontroller or microprocessor, which performs additional calculation on the data before providing the digital value at one or more of its output terminals.

7. An electronic component according to claim 6, wherein the digital output is provided through a serial interface.

8. An electronic component according to claim 6, wherein the digital output is provided through a parallel interface using a multiplicity of output terminals simultaneously.

9. An electronic component according to claim 7, wherein the output of one integrated circuit is connected to a second integrated circuit comprising non-volatile memory.

10. An electronic component according to claim 6, wherein the microcontroller is connected to or integrated with a wireless transceiver integrated circuit and an antenna is integrated into or connected to the analog circuit.

11. An electronic sensing component according to claim 2, wherein two resistors of constant value are connected in series with the sensing element such that the two potentials applied to the inputs of the integrated circuits are the potential difference across one of the resistors of constant value, and the potential difference across the said resistor of constant value and the sensing element, respectively.

12. An electronic component according to claim 8, wherein the output of one integrated circuit is connected to a second integrated circuit comprising non-volatile memory.
